(19) United States
(12) Patent Application Publication
(10) Pub. No.: US 2017/0260912 A1
(43) Pub. Date: Sep. 14, 2017

(54) EXHAUST SYSTEM OF ENGINE

(71) Applicant: MAZDA MOTOR CORPORATION, Hiroshima (JP)

(72) Inventors: Shuhei TSUJITA, Hatsukaichi-shi (JP); Einosuke SUEKUNI, Higashihiroshima-shi (JP); Mitsuyuki MUROTANI, Hiroshima-shi (JP); Junji UMEMURA, Aki-gun (JP)

(73) Assignee: MAZDA MOTOR CORPORATION, Hiroshima (JP)

(21) Appl. No.: 15/443,608

(22) Filed: Feb. 27, 2017

(30) Foreign Application Priority Data
Mar. 11, 2016 (JP) 2016-048728

(51) Int. Cl. F02D 9/10

(52) U.S. Cl. CPC F02D 9/1065; F02D 9/106

(57) ABSTRACT

An exhaust system of an engine includes a plate-like valve configured to change a cross-sectional area of an exhaust passage, a drive shaft configured to rotate the valve, a bearing provided for a wall member segmenting the exhaust passage to rotatably support the valve, and a driver configured to rotate the drive shaft. The drive shaft penetrates the wall member, and includes an extension extending outside the exhaust passage. The system also includes an auxiliary bearing that rotatably supports the extension of the drive shaft. The auxiliary bearing is spaced apart from the wall member by a predetermined distance.

### CROSS-REFERENCE TO RELATED APPLICATION

This application claims priority to Japanese Patent Application No. 2016-048728 filed on Mar. 11, 2016, the entire disclosure of which is incorporated by reference herein.

### BACKGROUND

The present disclosure relates to an exhaust system of an engine. Japanese Unexamined Patent Publication No. 2011-256942 describes providing a butterfly valve for an EGR passage, in which exhaust gas flows. The EGR passage includes a first passage and a second passage arranged horizontally. The butterfly valve is provided for each of the first and second passages. The two butterfly valves are fixed to a valve shaft crossing the first and second passages. The valve shaft is supported by a housing that segments the EGR passage on both sides of the valve shaft, with the two butterfly valves interposed therebetween. The valve shaft extends outside the EGR passage. A lever member is attached to an end of the valve shaft to be adjacent to the housing. The lever member is connected to a negative pressure actuator.

Japanese Unexamined Patent Publication No. 2014-80900 describes an engine with a turbocharger, in which an exhaust valve gear is provided between a turbine and independent exhaust passages that communicate with cylinders. The exhaust valve gear changes the flow area of exhaust gas discharged from the engine in accordance with the rotational speed of the engine, thereby changing the flow velocity of exhaust gas to be introduced into the turbine.

The exhaust system of Japanese Unexamined Patent Publication No. 2014-80900 will be further described in detail. This engine is an in-line four-cylinder engine including four cylinders (i.e., first to fourth cylinders). The independent exhaust passages include a first exhaust passage communicating with the first cylinder, a second exhaust passage communicating with the second and third cylinders, and a third exhaust passage communicating with the fourth cylinder. The exhaust valve gear includes an upstream exhaust passage connected to the independent exhaust passages. The turbocharger includes a downstream exhaust passage that connects the upstream exhaust passage to a turbine housing.

The upstream exhaust passage is composed of three independent passages communicating with the first to third exhaust passages, respectively. Each of the three passages is divided into two passages, namely, high- and low-speed passages. The downstream exhaust passage includes independent high- and low-speed passages that communicate with the high- and low-speed passages of the upstream exhaust passage, respectively. The high- and low-speed passages of the downstream exhaust passage meet the three passages that are independent from each other in the upstream exhaust passage. The downstream end of the downstream exhaust passage meets the high- and low-speed passages and is then connected to an inlet of the turbine.

The high-speed passage of the upstream exhaust passage is provided with a butterfly valve. A drive shaft connected to the butterfly valve is rotated by an actuator to open and close the butterfly valve.

When the engine rotates at a speed lower than or equal to a predetermined speed, the butterfly valve is closed. This limits the flow area of the exhaust gas to increase the flow velocity of the exhaust gas, thereby increasing the driving force of the turbine at low rotational speeds of the engine. On the other hand, at high rotational speeds of the engine, the exhaust gas can be introduced into the turbine through both the high- and low-speed passages. This configuration reduces exhaust resistance to increase the driving force of the turbine.

### SUMMARY

In the exhaust system of Japanese Unexamined Patent Publication No. 2014-80900, the valve is located in a relatively upstream position of the exhaust passage. In such an exhaust system, the exhaust gas passing through the passage has a higher temperature than in the configuration of Japanese Unexamined Patent Publication No. 2011-256942, in which the valve is located in an intermediate position of the EGR passage. Assume that the valve shaft connected to the negative pressure actuator is pivotably supported on both the sides of the valve shaft, with the two butterfly valves in the passages interposed therebetween, as in the valve arrangement described in Japanese Unexamined Patent Publication No. 2011-256942. Then, the bearing might expand thermally to increase the clearance between the shaft and the bearing. An increase in the clearance of the bearing causes rattling of the valve shaft. This leads to delay in rotation of the valve shaft when the negative pressure actuator operates to open or close the valve, resulting in lower responsiveness in opening and closing the valve.

The exhaust system of Japanese Unexamined Patent Publication No. 2014-80900 fully closes the butterfly valve when the rotational speed of the engine is lower than or equal to the predetermined speed, and fully opens the butterfly valve when the rotational speed of the engine exceeds the predetermined speed. Thus, this exhaust system requires high responsiveness in opening and closing the butterfly valve.

Not to increase the clearance between the valve shaft and the bearing due to the thermal expansion, materials may be selected so that the valve shaft has a higher coefficient of linear thermal expansion than the bearing. However, since an engine mounted in a vehicle generally operates within a wide range, this measure reduces the clearance between the valve shaft and the bearing too much, depending on the conditions of heat entering the valve shaft. Then, the valve shaft might be fixed and become unable to drive the valve.

The present disclosure was made in view of these problems, and aims to reduce, in an exhaust system of an engine including a valve in an exhaust passage, influence of the heat of exhaust gas on a bearing for a drive shaft rotating the valve to stably open and close the valve.

The present disclosure relates to an exhaust system of an engine. The exhaust system includes: a plate-like valve provided in an exhaust passage, and being rotatable to change a cross-sectional area of the exhaust passage, the exhaust passage connected to an exhaust port of a combustion chamber inside the engine; a drive shaft provided for the valve to rotate the valve; a bearing provided for a wall member constituting the exhaust passage to rotatably support the valve; and a driver connected to the drive shaft to rotate the drive shaft.

In this exhaust system of the engine, the drive shaft penetrates the wall member, and includes an extension extending outside the exhaust passage. The exhaust system also includes an auxiliary bearing configured to rotatably support the extension of the drive shaft. The auxiliary bearing is spaced apart from the wall member by a predetermined distance.

According to this configuration, the drive shaft penetrates the wall member provided with the bearing supporting the valve, and extends outside the exhaust passage. This extension is rotatably supported by the auxiliary bearing. The auxiliary bearing is spaced apart from the wall member by a predetermined distance. Thus, the auxiliary bearing is less influenced by the heat of the exhaust gas flowing through the exhaust passage.

As a result, the clearance between the drive shaft and the auxiliary bearing less increases at the auxiliary bearing. This prevents or reduces the rattling of the drive shaft so that the drive shaft rotates with high responsiveness upon receipt of the driving force from the driver, and eventually the valve in the exhaust passage opens and closes with increased responsiveness.

The extension of the drive shaft may include a connector connected to the driver to rotate the drive shaft by swinging about the drive shaft. The connector is located opposite to the wall member with the auxiliary bearing interposed therebetween.

The drive shaft receives the driving force through the connector connected to the driver. The connector is located opposite to the wall member with the auxiliary bearing interposed therebetween. That is, the auxiliary bearing is located between the connector and the valve that is supported by the bearing of the wall member.

In this configuration, the driving force is supplied from the driver through the connector, and the drive shaft rotates about the auxiliary bearing between the connector and the valve as the fulcrum in opening and closing the valve. As a result, the valve opens and closes reliably.

The drive shaft may be formed by connecting a shaft member independent from the valve to an end of the valve adjacent to the bearing.

In this configuration, the valve and the drive shaft are independent members. Thus, less heat is transferred from the valve in the exhaust passage to the shaft member (i.e., the drive shaft). As a result, the clearance between the drive shaft and the auxiliary bearing is less reduced at the auxiliary bearing due to the thermal expansion of the drive shaft. This may reduce the chances of fixing of the drive shaft, thereby allowing the valve to open and close reliably during the operation of the engine.

The drive shaft may include an exposed portion of the extension between the wall member and the auxiliary bearing.

This configuration may increase heat transfer resistance between the wall member and the auxiliary bearing, thereby effectively reducing the thermal expansion of the auxiliary bearing.

### BRIEF DESCRIPTION OF THE DRAWINGS

FIG. 1 is a partial cross-sectional schematic view illustrating a structure of an exhaust system of an engine.

FIG. 2 is a cross-sectional view illustrating the structure of the exhaust system of the engine.

FIG. 3 is a perspective view illustrating a structure of an exhaust valve gear as viewed from a turbine.

FIG. 4 is a side view illustrating the structure of the exhaust valve gear.

FIG. 5 is a cross-sectional view taken along the line V-V of FIG. 3.

FIG. 6 is a cross-sectional view taken along the line VI-VI of FIG. 3.

FIG. 7 is an enlarged perspective view illustrating engagement of a lever member.

FIG. 8 is a cross-sectional view illustrating an engagement structure of the lever member.

FIG. 9 is a perspective view of a lever engaging portion and the lever member.

FIG. 10 is a cross-sectional view of a negative pressure actuator.

FIG. 11 is a control map for opening and closing a variable exhaust valve.

### DETAILED DESCRIPTION

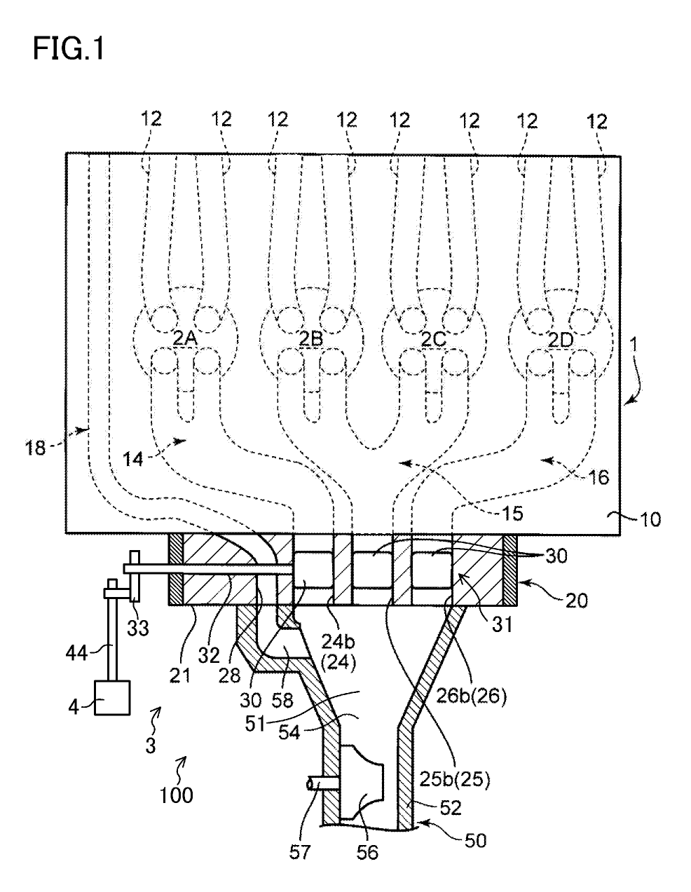

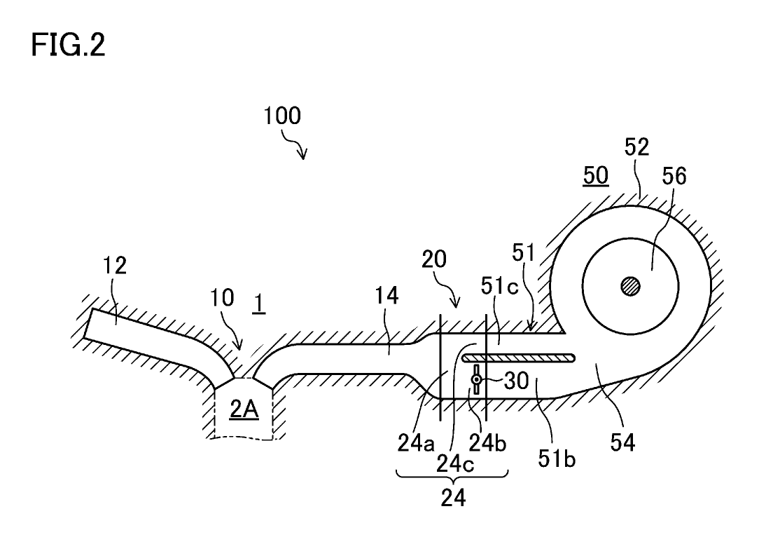

An exhaust system of an engine disclosed herein will now be described in detail with reference to the drawings. The following description is merely illustrative. FIGS. 1 and 2 illustrate an exhaust system 100 of an engine. The engine shown in these figures is an in-line four-cylinder, four-cycle engine with a turbocharger 50. In this embodiment, combustion is performed in the order of first, third, fourth, and second cylinders. This engine includes an engine body 1, in which four cylinders 2A-2D (a first cylinder 2A, a second cylinder 2B, a third cylinder 2C, and a fourth cylinder 2D) are arranged in a line. The exhaust system 100 includes an exhaust manifold, an exhaust valve gear 20, and the turbocharger 50. The exhaust manifold constitutes a part of an exhaust passage that connects an exhaust port of a combustion chamber inside the engine body 1 to a catalyst system (not shown) located outside the engine body 1 to discharge exhaust gas generated in the combustion chamber. The exhaust valve gear 20 will be described later in detail.

This engine does not include an independent member as the exhaust manifold. As will be described later in detail, independent exhaust passages 14, 15, and 16 of the engine body 1 (i.e., a cylinder head 10), upstream exhaust passages 24, 25, and 26 of the exhaust valve gear 20, and an exhaust gas intake passage 51 and a junction 54 of the turbocharger 50 cooperate with each other to form the exhaust manifold.

The engine allows exhaust gas discharged through the exhaust manifold to activate the turbocharger 50, which compresses intake gas introduced into the cylinders 2A-2D to raise intake pressure. Then, the exhaust valve gear 20 interposed between the engine body 1 and the turbocharger 50 controls the flow velocity of exhaust gas introduced into the turbocharger 50 in accordance with the operating state of the vehicle. As a result, this turbocharger 50 advantageously increases engine torque in a wide range of the engine from low to high rotation speeds.

In the description, the following expressions are used to clearly define the directional relation with reference to FIG. 1. The cylinders 2A-2D of the engine body 1 are aligned in a “horizontal” direction. The “horizontal” direction is orthogonal to a “longitudinal” direction (i.e., the vertical direction in FIG. 1). The turbocharger 50 is located at the “front” of the engine.

The cylinder head 10 of the engine body 1 includes three independent exhaust passages for the four cylinders 2A-2D. Specifically, the first independent exhaust passage 14 is used to exhaust gas from the first cylinder 2A. The second independent exhaust passage 15 is used in common to exhaust gas from the second and third cylinders 2B and 2C, from which the gas is not exhausted one after the other. The third independent exhaust passage 16 is used to exhaust gas from the fourth cylinder 2D. The second independent exhaust passage 15 is divided in a Y-shape at the upstream portion to be shared by the second and third cylinders 2B and 2C.

The downstream ends of these independent exhaust passages 14, 15, and 16 collect at the substantial center of the cylinder head 10 in the horizontal direction. The downstream ends are arranged horizontally adjacent to each other and open at the front of the cylinder head 10.

The cylinder head 10 includes an EGR downstream passage 18. As shown in FIG. 1, this EGR downstream passage 18 passes longitudinally in the cylinder head 10 on the left of the first cylinder 2A. The upstream end of this EGR downstream passage 18 is open at the front of the cylinder head 10 on the left of the independent exhaust passage 14. On the other hand, the downstream end of the EGR downstream passage 18 is open at the rear of the cylinder head 10. In FIG. 1, reference numeral 12 represents intake ports of the cylinders 2A-2D formed in the cylinder head 10. The downstream end of the EGR downstream passage 18 is open on the left of the intake port 12 of the first cylinder 2A.

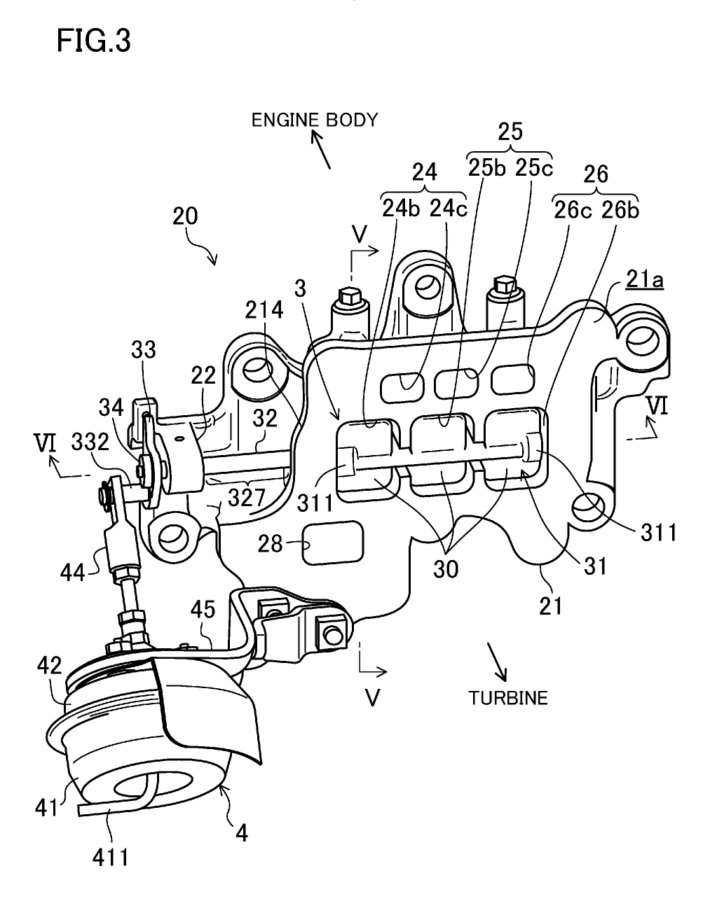

FIG. 3 illustrates the exhaust valve gear 20 as viewed from a turbine. The exhaust valve gear 20 changes the flow area of exhaust gas discharged from the engine body 1 to change the flow velocity of the exhaust gas to be introduced into the turbocharger 50. The exhaust valve gear 20 is bolted to the front surface of the engine body 1.

This exhaust valve gear 20 includes a gear body 21 and a variable exhaust valve 3. The gear body 21 includes the three independent upstream exhaust passages 24, 25, and 26 (i.e., the first, second, and third upstream exhaust passages 24, 25, and 26) and an EGR intermediate passage 28. The upstream exhaust passages 24, 25, and 26 communicate with the independent exhaust passages 14, 15, and 16 of the cylinder head 10, respectively. The EGR intermediate passage 28 communicates with the EGR downstream passage 18 of the cylinder head 10. The variable exhaust valve 3 is for changing the flow area of the exhaust gas in the upstream exhaust passages 24, 25, and 26. The gear body 21 is a metal cast. The gear body 21 constitutes a wall member segmenting the exhaust passages.

The downstream portions of the upstream exhaust passages 24, 25, and 26 are divided in a Y-shape. Specifically, as shown in FIGS. 2 and 3, the first upstream exhaust passage 24 includes a common passage 24a, a high-speed passage 24b, and a low-speed passage 24c. The common passage 24a communicates with the first independent exhaust passage 14 of the cylinder head 10. The high- and low-speed passages 24b and 24c are branched vertically from the common passage 24a. The second and third upstream exhaust passages 25 and 26 also include common passages 25a and 26a (not shown), high-speed passages 25b and 26b, and low-speed passages 25c and 26c, respectively. The common passages 25a and 26a communicate with the independent exhaust passages 15 and 16 of the cylinder head 10, respectively. The high- and low-speed passages 25b and 25c are branched vertically from the common passage 25a, and the high- and low-speed passages 26b and 26c are branched from the common passage 26a. The low-speed passages 24c, 25c, and 26c have smaller cross-sectional flow areas than the high-speed passages 24b, 25b, and 26b.

The high-speed passages 24b, 25b, and 26b have a substantially rectangular cross-section, and are aligned horizontally as shown in FIG. 3. The low-speed passages 24c, 25c, and 26c also have a substantially rectangular cross-section, and are aligned horizontally above the high-speed passages 24b, 25b, and 26b, respectively.

On the other hand, as shown in FIGS. 1 and 3, the EGR intermediate passage 28 is disposed in the left portion of the gear body 21. This EGR intermediate passage 28 has a substantially rectangular cross-section, and is located on the lower left of the high-speed passage 24b of the first upstream exhaust passage 24.

The variable exhaust valve 3 changes the flow area of the exhaust gas in the high-speed passages 24b, 25b, and 26b of the upstream exhaust passages 24, 25, and 26. This variable exhaust valve 3 includes a valve body 31, a drive shaft 32, and a negative pressure actuator 4. The valve body 31 includes three butterfly valves 30 disposed in the high-speed passages 24b, 25b, and 26b, respectively. The drive shaft 32 is connected to the valve body 31. The negative pressure actuator 4 rotates the drive shaft 32. The variable exhaust valve 3 allows the negative pressure actuator 4 to rotationally drive the butterfly valves 30 via the drive shaft 32, thereby opening and closing the high-speed passages 24b, 25b, and 26b at the same time.

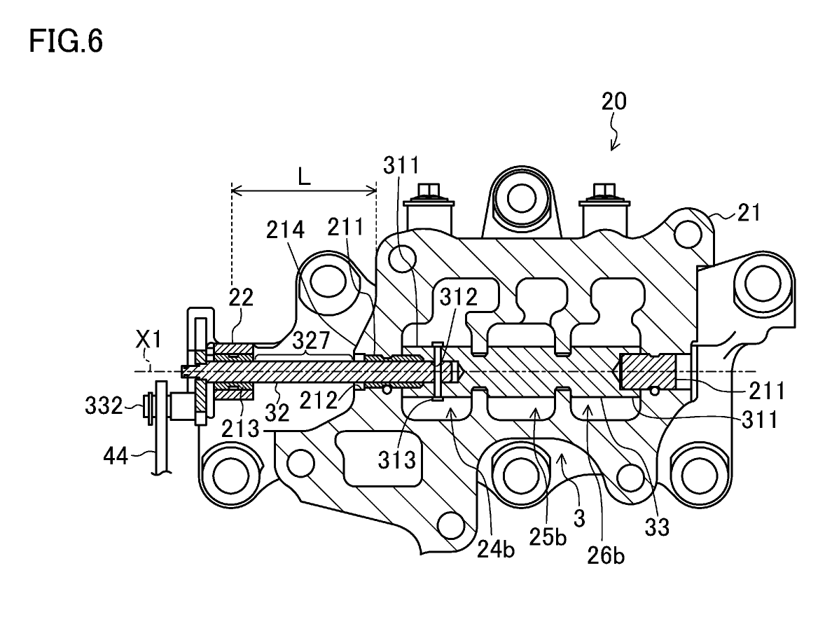

The structure of the variable exhaust valve 3 will now be described specifically. As shown in FIGS. 3-6, the valve body 31 is formed by connecting the three horizontally aligned butterfly valves 30 together. The transverse sectional centers of the horizontally aligned high-speed passages 24b, 25b, and 26b horizontally communicate with each other. As shown in FIGS. 3 and 6, the valve body 31 extends horizontally across the transverse sectional centers of the communicating high-speed passages 24b, 25b, and 26b. Supports 311 are provided at the right and left ends of the valve body 31 to be integral with the valve body 31. Each support 311 has a support hole, which is open to the end surface of the valve body 31. Valve support bushes 211 attached to the gear body 21 are inserted into the two supports 311 so that the valve body 31 is rotatable about an axis X1. Being subjected to high-temperature exhaust gas, the valve body 31 is made of a heat-resistant material.

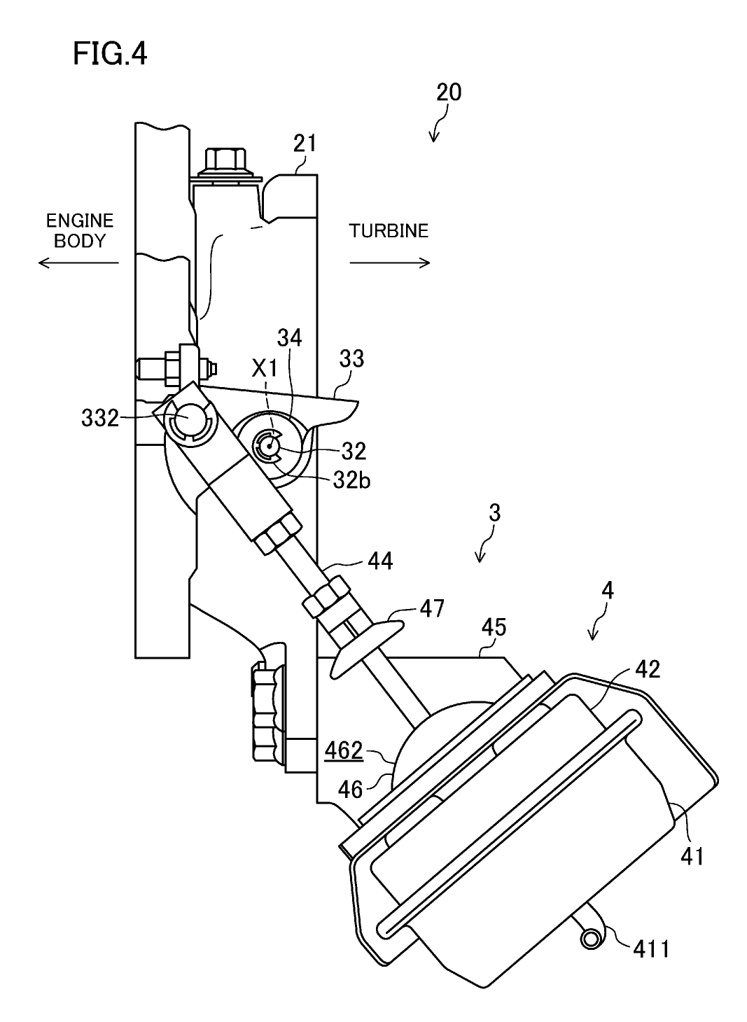

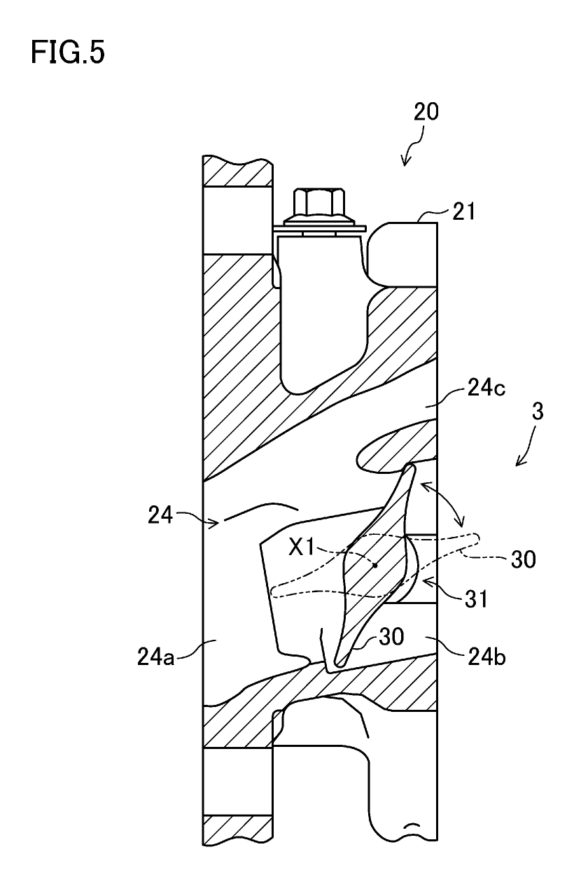

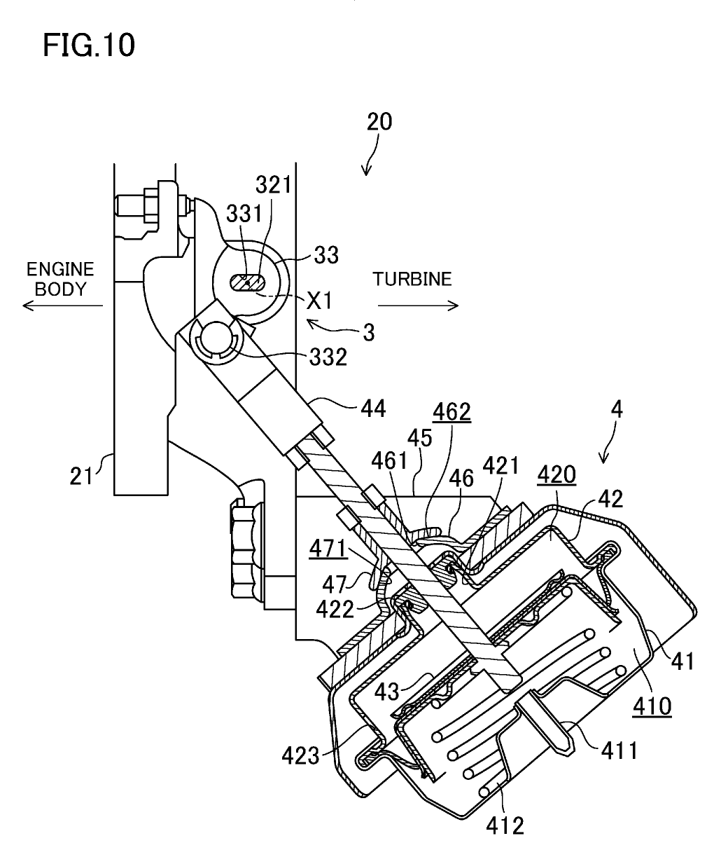

As shown in FIGS. 3 and 5, the butterfly valves 30 are rectangular plates corresponding to the cross-sections of the high-speed passages 24b, 25b, and 26b. When a stopper engaging portion 47 of the negative pressure actuator 4, which will be described later, abuts on a stopper 46 (see FIG. 10), each butterfly valve 30 closes the associated one of the high-speed passages 24b, 25b, and 26b as indicated by the solid line in FIG. 5. From this state, when the negative pressure actuator 4 operates and the stopper engaging portion 47 moves away from the stopper 46 (see FIG. 4), the valve body 31 rotates clockwise in FIG. 5 so that each butterfly valve 30 opens the associated one of the high-speed passages 24b, 25b, and 26b as indicated by the two-dotted line.

The drive shaft 32 is connected to the left end of the valve body 31. As shown in FIG. 6, a recess 312 is formed at the left end of the valve body 31. The recess 312 is open to the left end surface of the valve body 31 and recessed along the axis of the valve body 31. The recess 312 has a relatively small depth.

The base end of the drive shaft 32 (i.e., the right end in FIG. 6) is inserted into the recess 312. The base end of the drive shaft 32 is fixed to the valve body 31 with a fastening pin 313 penetrating the drive shaft 32 orthogonally. The fastening pin 313 also penetrates the valve body 31. Both the ends of the fastening pin 313 are caulked to the outer peripheral surface of the valve body 31.

The drive shaft 32 passes through a through-hole 212 and extends outside on the left of the upstream exhaust passages 24, 25, and 26. The through-hole 212 is formed in the gear body 21 to receive the valve support bush 211 inserted therein. The tip of the drive shaft 32 opposite to the exhaust passages is held by a shaft support bush 213 rotatably about the axis X1. The shaft support bush 213 is attached to an auxiliary bearing 22 which is integral with the gear body 21. As also shown in FIG. 3, the auxiliary bearing 22 is spaced apart from the upstream exhaust passages 24, 25, and 26 by a predetermined distance. In other words, the auxiliary bearing 22 is spaced apart from a wall member 214 of the gear body 21, which includes the valve support bush 211 as a bearing that supports the valve body 31, by a predetermined distance L. The drive shaft 32 includes an exposed portion 327 between the wall member 214 of the gear body 21 and the auxiliary bearing 22.

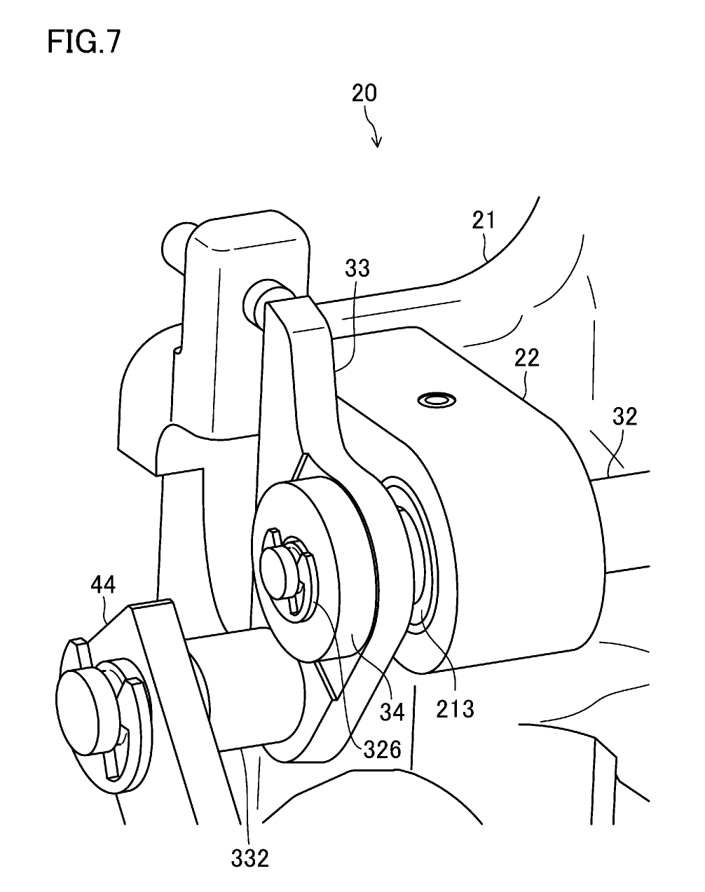

As shown in FIGS. 4 and 7, a lever member 33 as a connector is attached to the tip of the drive shaft 32, specifically, the tip of the drive shaft 32 protruding beyond the shaft support bush 213 to the left.

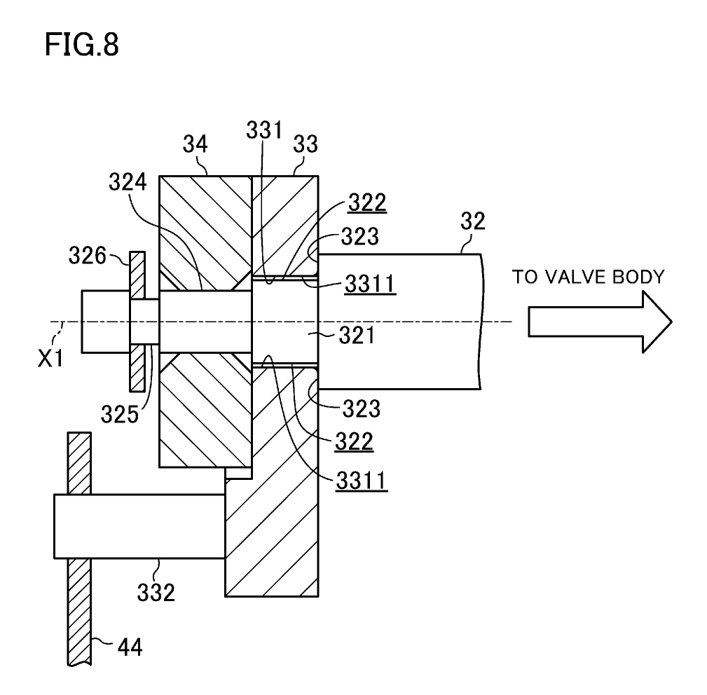

The lever member 33 is attached to a lever engaging portion 321 at the tip of the drive shaft 32. As shown in FIGS. 8-10, the lever engaging portion 321 is formed by processing two portions of the peripheral surface of the drive shaft 32 into flat planes. The two flat planes 322 of the lever engaging portion 321 are provided on both the sides of the drive shaft 32, with the shaft center of the drive shaft 32 interposed therebetween. The two flat planes 322 are parallel to each other. The lever engaging portion 321 has a non-circular transverse section.

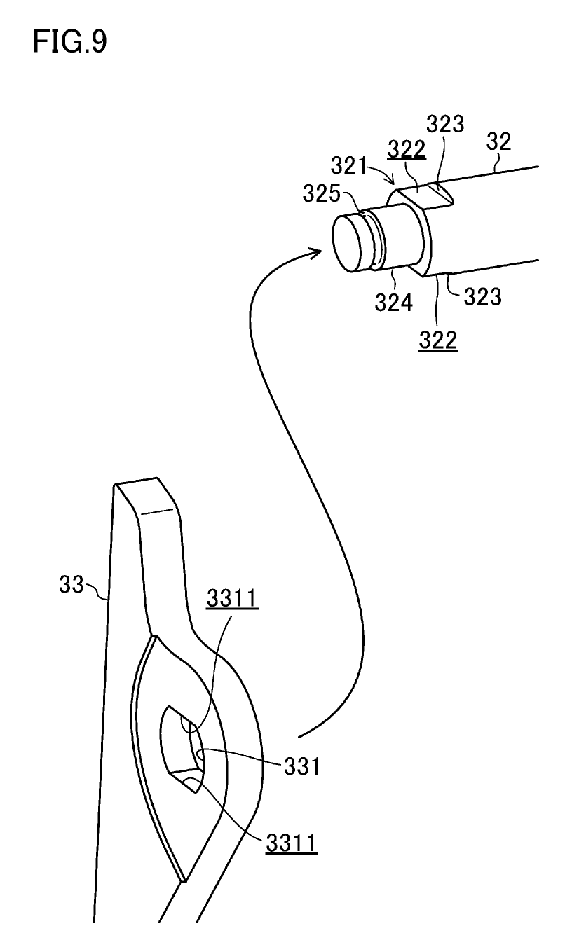

The shape of the lever member 33 corresponds to the transverse section of the lever engaging portion 321. A through-hole 331 is formed in the lever member 33 and has a cross-sectional area so that the lever engaging portion 321 is inserted into the through-hole 331. As shown in FIGS. 8 and 9, the through-hole 331 has two parallel flat planes 3311 on its inner peripheral surface. The lever member 33 is fitted onto the lever engaging portion 321 such that each of the two flat planes 322 faces the associated one of the two flat planes 3311. In this manner, the lever engaging portion 321 has a non-circular transverse section, and the shape of the through-hole 331 of the lever member 33 corresponds to the transverse section of the lever engaging portion 321. Thus, the drive shaft 32 is easily positioned in the rotation direction, when the lever member 33 is attached to the drive shaft 32.

Second abutting portions 323 are adjacent to the lever engaging portion 321 of the drive shaft 32 on the side closer to the butterfly valves 30. The second abutting portions 323 abut on a side surface of the lever member 33 and are integral with the drive shaft 32. The second abutting portions 323 are formed in the drive shaft 32 by the plane processing of the drive shaft 32.

A press-fitting portion 324 is adjacent to the lever engaging portion 321 of the drive shaft 32 on the side opposite to the butterfly valves 30. The press-fitting portion 324 has a circular transverse section with a smaller diameter than the drive shaft 32. The press-fitting portion 324 has a smaller diameter than the lever engaging portion 321. A step is provided between the press-fitting portion 324 and the lever engaging portion 321.

A first abutting member 34 independent from the drive shaft 32 is press-fitted on the press-fitting portion 324. The first abutting member 34 is a disk-like member with a larger diameter than the drive shaft 32. A through-hole with a circular transverse section is formed at the center of the first abutting member 34. The first abutting member 34 is press-fitted on the press-fitting portion 324 to be fixed to the drive shaft 32. After being press-fitted on the press-fitting portion 324, the first abutting member 34 abuts on another side surface of the lever member 33. The lever member 33 is sandwiched between the first abutting member 34 and the second abutting portions 323 along the axis of the drive shaft 32 to be firmly fixed to the drive shaft 32.

As shown in FIG. 9, a groove 325 is formed at a position closer to the tip of the drive shaft 32 along the entire circumference of the drive shaft 32. An E-ring 326 is attached to this groove 325 to stop the first abutting member 34.

As shown in FIG. 8, for example, the lever member 33 includes a pin 332 at the center of the through-hole 331, that is, in a position spaced apart from the axis X1 of the drive shaft 32 by a predetermined distance. The pin 332 is parallel to the drive shaft 32. The pin 332 is connected to the tip of an output shaft 44 of the negative pressure actuator 4.

As shown in FIGS. 3 and 4, the negative pressure actuator 4 is located closer to a turbine 56 than the engine body 1, with the gear body 21 interposed therebetween. The negative pressure actuator 4 is fixed to the gear body 21 via a bracket 45 provided for the negative pressure actuator 4. As shown in FIG. 10, the negative pressure actuator 4 includes a first casing 41, a second casing 42, a diaphragm 43, and the output shaft 44.

The first and second casings 41 and 42 are in a cup shape, and are opposed and jointed to each other. This configuration provides a space inside the negative pressure actuator 4.

The diaphragm 43 is interposed between the first and second casings 41 and 42. The diaphragm 43 divides the space in the negative pressure actuator 4 into a negative pressure chamber 410 located in the first casing 41 and a positive pressure chamber 420 located in the second casing 42.

The output shaft 44 is connected to the diaphragm 43. The output shaft 44 passes through a through-hole 421 formed in the second casing 42 and extends opposite to the negative pressure chamber 410. As described above, the tip of the output shaft 44 is connected to the pin 332 of the lever member 33. The output shaft 44 extends obliquely downward from the gear body 21 toward the turbine 56. The output shaft 44 moves forward and backward in accordance with the shift of the diaphragm 43. The lever member 33 swings about the shaft center X1 of the drive shaft 32 in accordance with the forward and backward movement of the output shaft 44. The drive shaft 32 rotates about the axis X1.

The bush 422 is attached to the inside of the through-hole 421 of the second casing 42. The bush 422 is fitted onto the output shaft 44. The bush 422 is in close contact with the output shaft 44 to keep the inside of the positive pressure chamber 420 airtight. When the output shaft 44 moves forward and backward, the bush 422 allows the output shaft 44 to slide.

A negative pressure pipe 411 is connected to the bottom of the first casing 41. Negative pressure of intake gas is applied to, and discharged from, the negative pressure chamber 410 through the negative pressure pipe 411. A compression spring 412 is provided inside the negative pressure chamber 410. The compression spring 412 biases the diaphragm 43 in the forward direction of the output shaft 44. FIG. 10 illustrates that negative pressure is applied to the negative pressure chamber 410. A connecting hole 423 is formed in the second casing 42 to connect the inside to the outside of the second casing 42. The inside of the positive pressure chamber 420 is kept at the atmospheric pressure. When the negative pressure is applied to the negative pressure chamber 410, the difference in the pressure between the negative and positive pressure chambers 410 and 420 is exerted on the diaphragm 43, which moves the output shaft 44 backward, that is, toward the negative pressure chamber. When the negative pressure is discharged from the negative pressure chamber 410, the biasing force of the compression spring 412 moves the output shaft 44 forward, that is, opposite to the negative pressure chamber.

The stopper 46 is attached to the bracket 45 of the negative pressure actuator 4. In this embodiment, the stopper 46 is attached to the bracket 45 because the bracket 45 is located in the course of the output shaft 44 moving forward and backward. However, the stopper 46 only needs to be attached in the course of the output shaft 44 moving forward and backward. For example, if the bracket 45 is located out of the course, the stopper 46 may be directly attached to the body of the negative pressure actuator 4.

The stopper engaging portion 47 is fixed to the output shaft 44 and engaged with the stopper 46. The stopper 46 and the stopper engaging portion 47 are engaged with each other when the output shaft 44 moves backward to prevent the output shaft 44 from moving more backward.

The stopper 46 is a hat-like member with a shaft-passing hole 461 at the center. The output shaft 44 passes through the shaft-passing hole 461. This shaft-passing hole 461 has a sufficiently larger diameter than the output shaft 44. The stopper 46 has a first abutting surface 462 raised at the center including the shaft-passing hole 461.

The stopper engaging portion 47 is fixed at an intermediate portion of the output shaft 44. The stopper engaging portion 47 has a second abutting surface 471 abutting on the first abutting surface 462 of the stopper 46. The second abutting surface 471 is a concave surface.

To close the variable exhaust valve 3 in the exhaust valve gear 20 with this configuration, the negative pressure of the intake gas is applied to the negative pressure chamber 410 of the negative pressure actuator 4 (i.e., the negative pressure actuator is turned on). Thus, the output shaft 44 is retracted backward. Then, the lever member 33 is positioned as shown in FIG. 10 so that the butterfly valves 30 close the high-speed passages 24b, 25b, and 26b as indicated by the solid line of FIG. 5.

On the other hand, to open the variable exhaust valve 3, the negative pressure of the intake gas is discharged from the negative pressure chamber 410 of the negative pressure actuator 4 (i.e., the negative pressure actuator is turned off). As a result, the biasing force of the compression spring 412 pushes out the output shaft 44 forward. Then, the lever member 33 rotates clockwise to be positioned as shown in FIG. 4 so that each butterfly valve 30 opens the associated one of the high-speed passages 24b, 25b, and 26b as indicated by the two-dotted line of FIG. 5. The variable exhaust valve 3 is normally open.

As shown in FIGS. 1 and 2, the turbocharger 50 is bolted to the gear body 21 of the exhaust valve gear 20. The turbocharger 50 includes an exhaust gas intake passage 51, a turbine housing 52, the turbine 56, and a compressor. The exhaust gas intake passage 51 is fixed to a mounting surface 21a of the gear body 21 (see FIG. 3). The turbine housing 52 is continuous with the exhaust gas intake passage 51. The turbine 56 is provided in this turbine housing 52. The compressor is connected to the turbine 56 via a connecting shaft 57 and provided in an intake passage (not shown).

The exhaust gas intake passage 51 includes a high-speed passage 51b and a low-speed passage 51c, which are independent from each other. The high-speed passage 51b communicates with the high-speed passages 24b, 25b, and 26b of the exhaust valve gear 20. The low-speed passage 51c communicates with the low-speed passages 24c, 25c, and 26c of the exhaust valve gear 20. Although not shown in detail, the three high-speed passages 24b, 25b, and 26b, which are independent from each other in the exhaust valve gear 20, meet together at the high-speed passage 51b of the exhaust gas intake passage 51. Similarly, the three low-speed passages 24c, 25c, and 26c, which are independent from each other in the exhaust valve gear 20, meet together at the low-speed passage 51c of the exhaust gas intake passage 51.

The exhaust gas intake passage 51 includes a junction 54 between the high- and low-speed passages 51b and 51c at its downstream end. The exhaust gas coming from the high-speed passage 51b of the downstream exhaust passage and the gas coming from the low-speed passage 51c of the downstream exhaust passage meet at this junction 54 to be sent to the turbine 56.

As described above, this engine does not include any independent member as the exhaust manifold. The independent exhaust passages 14, 15, and 16 of the engine body 1 (i.e., the cylinder head 10), the upstream exhaust passages 24, 25, and 26 of the exhaust valve gear 20, and the exhaust gas intake passage 51 and the junction 54 of the turbocharger 50 are combined to form the exhaust manifold.

An EGR upstream passage 58 is formed on the left of the exhaust gas intake passage 51 of the turbine housing 52 and communicates with the EGR intermediate passage 28 of the exhaust valve gear 20. Part of the exhaust gas flowing to the turbocharger 50 is introduced as EGR gas into the intake passage through the EGR upstream passage 58, the EGR intermediate passage 28, and the EGR downstream passage 18. That is, in this engine, the EGR downstream passage 18, the EGR intermediate passage 28, and the EGR upstream passage 58 form an EGR passage.

In the engine configured as described above, the exhaust gas generated in the engine body 1 is introduced from the independent exhaust passages 14, 15, and 16 into the turbocharger 50 via the upstream exhaust passages 24, 25, and 26 of the exhaust valve gear 20. At this time, the flow area of the exhaust gas flowing through the high-speed passages 24b, 25b, and 26b of the exhaust valve gear 20 are changed in accordance with the operating state of the vehicle.

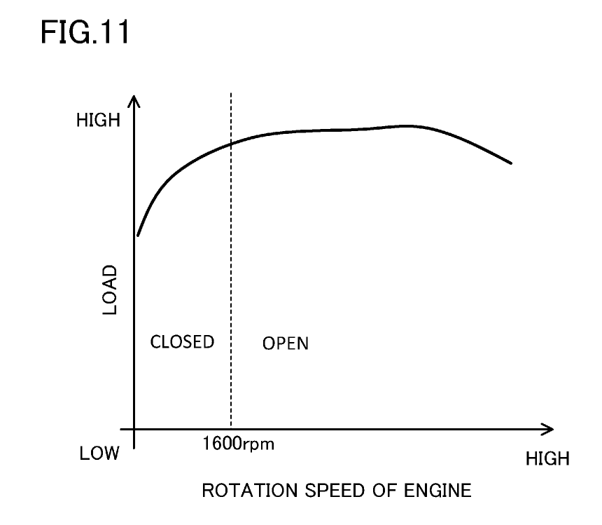

Specifically, as shown in FIG. 11, when the engine body 1 rotates at a low speed lower than or equal to a predetermined speed (e.g., 1600 rpm), the exhaust valve gear 20 is controlled to close the high-speed passages 24b, 25b, and 26b. That is, the negative pressure of the intake gas is applied to the negative pressure chamber 410 of the negative pressure actuator 4 to retract the output shaft 44 backward. Accordingly, the lever member 33 is positioned as shown in FIG. 10, and each butterfly valve 30 closes the associated one of the high-speed passages 24b, 25b, and 26b as indicated by the solid line of FIG. 5. A small amount of exhaust gas is concentrated at the low-speed passages 24c, 25c, and 26c to increase the flow velocity of the exhaust gas. This increases the driving force of the turbine 56 of the turbocharger 50 to raise intake pressure.

On the other hand, when the engine body 1 rotates at a high speed exceeding the predetermined speed, the exhaust valve gear 20 is controlled to open the high-speed passages 24b, 25b, and 26b. This is because exhaust performance might be degraded by the resistance of the exhaust passage if the exhaust gas passes through the low-speed passages 24c, 25c, and 26c only. That is, the negative pressure of the intake gas is discharged from the negative pressure chamber 410 of the negative pressure actuator 4 so that the biasing force of the compression spring 412 pushes out the output shaft 44 forward. As a result, the lever member 33 is positioned as shown in FIG. 4 so that each butterfly valve 30 opens the associated one of the high-speed passages 24b, 25b, and 26b as indicated by the two-dotted line of FIG. 5. The exhaust gas is introduced into the turbocharger 50 through both the high-speed passages 24b, 25b, and 26b and the low-speed passages 24c, 25c, and 26c. This reduces the degradation in the exhaust performance caused by the resistance of the exhaust passage and drives the turbocharger 50 to raise the intake pressure. The variable exhaust valve 3 is switched between a fully open state and a fully closed state with respect to the predetermined rotational speed. Therefore, the variable exhaust valve 3 needs to have improved responsiveness in opening and closing.

In the exhaust system 100 of the engine with the configuration described above, the drive shaft 32 rotating the valve body 31 penetrates the gear body 21 including the valve support bush 211 which supports the valve body 31. The drive shaft 32 extends outside the high-speed passages 24b, 25b, and 26b, and is supported by the auxiliary bearing 22. As shown in FIG. 6, the auxiliary bearing 22 is spaced apart from the high-speed passages 24b, 25b, and 26b. Accordingly, the auxiliary bearing 22 is less influenced by the heat of the exhaust gas flowing through the exhaust passages. As a result, the clearance between the drive shaft 32 and the shaft support bush 213 less increases at the auxiliary bearing 22, thereby reducing rattling of the drive shaft 32. The negative pressure actuator 4 allows the drive shaft 32 to rotate with high responsiveness. Eventually, the butterfly valves 30 in the high-speed passages 24b, 25b, and 26b open and close with increased responsiveness.

The lever member 33 is attached to the extension of the drive shaft 32 on the side opposite to the valve support bush 211, with the auxiliary bearing 22 interposed therebetween. The driving force is input to the drive shaft 32 through the lever member 33 that is connected to the negative pressure actuator 4. The auxiliary bearing 22 is located between the lever member 33 and the valve body 31 that is supported by the valve support bush 211.

With this configuration, when the driving force is input from the negative pressure actuator 4 through the lever member 33 to open and close the butterfly valves 30, the drive shaft 32 rotates about the auxiliary bearing 22 as the fulcrum. As a result, the butterfly valves 30 open and close reliably.

The drive shaft 32 is a shaft member connected to the valve body 31 and independent from the valve body 31. This configuration may prevent or reduce heat transfer from the butterfly valves 30 in the high-speed passages 24b, 25b, and 26b to the drive shaft 32. As a result, the clearance is less reduced between the drive shaft 32 and the shaft support bush 213 at the auxiliary bearing 22 due to thermal expansion of the drive shaft 32. This may reliably reduce the chances of fixing of the drive shaft 32, thereby allowing the butterfly valves 30 to open and close reliably.

The drive shaft 32 includes an exposed portion 327 between the wall member 214 of the gear body 21 and the auxiliary bearing 22. This configuration provides a higher heat transfer resistance between the wall member 214 and the auxiliary bearing 22 than, for example, the configuration including no exposed portion 327, but a cover surrounding at least part of the drive shaft 32 between the wall member 214 and the auxiliary bearing 22 to connect the wall member 214 to the auxiliary bearing 22. This contributes to effective prevention or reduction in thermal expansion of the auxiliary bearing 22. That is, this may reliably prevent or reduce the increase in the clearance between the auxiliary bearing 22 and the drive shaft 32 due to the heat entering the auxiliary bearing 22, and the rattling which occurs if the clearance increases.

In the above embodiment, an exemplary example has been described where the engine is a multi-cylinder engine with a turbocharger. The specific configurations of the engine and the exhaust valve gear 20 mounted therein can be modified as appropriate within the scope of the present disclosure.

In the above embodiment, an example has been described where the exhaust system is applied to an in-line four-cylinder, four-cycle engine. The exhaust system disclosed herein is also applicable to any other engine.

What is claimed is:

1. An exhaust system of an engine, the exhaust system comprising:
a plate-like valve provided in an exhaust passage, and being rotatable to change a cross-sectional area of the exhaust passage, the exhaust passage connected to an exhaust port of a combustion chamber inside the engine;
a bearing provided for a wall member constituting the exhaust passage to rotatably support the valve;
a drive shaft provided for the valve to rotate the valve, penetrating the wall member, and including an extension extending outside the exhaust passage;
an auxiliary bearing configured to rotatably support the extension of the drive shaft, and spaced apart from the wall member by a predetermined distance; and
a driver connected to the drive shaft to rotate the drive shaft.

2. The exhaust system of claim 1, wherein
the extension of the drive shaft includes a connector connected to the driver to rotate the drive shaft by swinging about the drive shaft, and
the connector is located opposite to the wall member with the auxiliary bearing interposed therebetween.

3. The exhaust system of claim 1, wherein
the drive shaft is formed by connecting a shaft member independent from the valve to an end of the valve adjacent to the bearing.

4. The exhaust system of claim 2, wherein
the drive shaft is formed by connecting a shaft member independent from the valve to an end of the valve adjacent to the bearing.

5. The exhaust system of claim 1, wherein
the drive shaft includes an exposed portion of the extension between the wall member and the auxiliary bearing.

6. The exhaust system of claim 2, wherein
the drive shaft includes an exposed portion of the extension between the wall member and the auxiliary bearing.

7. The exhaust system of claim 3, wherein
the drive shaft includes an exposed portion of the extension between the wall member and the auxiliary bearing.

8. The exhaust system of claim 4, wherein
the drive shaft includes an exposed portion of the extension between the wall member and the auxiliary bearing.
